(19) United States
(12) Patent Application Publication
(10) Pub. No.: US 2013/0136904 A1
(43) Pub. Date: May 30, 2013

(54) Winder Liner for Unvulcanized Rubber Material

(71) Applicants: Sujith Nair, Greer, SC (US); Howell B. Eleazer, Chesnee, SC (US); Purushothama K. Ullal, Singapore (SG); Padmakumar Puthillath, Greer, SC (US); Thomas W. Newbill, LaGrange, GA (US); Kevin Hazen, Spartanburg, SC (US); Gary K. Greene, Mooresboro, NC (US)

(72) Inventors: Sujith Nair, Greer, SC (US); Howell B. Eleazer, Chesnee, SC (US); Purushothama K. Ullal, Singapore (SG); Padmakumar Puthillath, Greer, SC (US); Thomas W. Newbill, LaGrange, GA (US); Kevin Hazen, Spartanburg, SC (US); Gary K. Greene, Mooresboro, NC (US)

(21) Appl. No.: 13/307,141

(22) Filed: Nov. 30, 2011

(51) Int. Cl. B32B 25/08; B32B 38/00; B32B 25/10; B32B 5/26; B32B 3/10

(52) U.S. Cl. 428/196; 442/186; 156/148

(57) ABSTRACT

A winder liner for unvulcanized rubber material comprising a first woven layer, a second woven layer, and a polymer layer. The first and second woven layers each contain a plurality of warp tape elements in a warp direction interwoven with a plurality of weft tape elements in a weft direction and a plurality of interstices between the warp and weft tape elements. The polymer layer is disposed on the inner surfaces of the first woven layer and the second woven layer and in the interstices of the first woven layer and the second woven layer. The polymer layer contains a first polymer comprising a co-polymer having at least 50% α-olefin units and is characterized by a number-average molecular weight of about 7,000 to 500,000 g/mol, and a viscosity of between about 2,500 and 150,000 cP measured at 170° C.

### TECHNICAL FIELD

The present invention relates to winder liners to be used to take up unvulcanized rubber material such as for tires.

### BACKGROUND

Unvulcanized rubber materials are sometimes temporarily stored between a step for feeding the unvulcanized rubber members and a step for using such unvulcanized rubber members, such as in tire construction. In such cases, the unvulcanized rubber members are generally temporarily stored flat or in a rolled fashion in the state that the unvulcanized rubber member is backed by a winder liner.

There is a need for high performance winder liners that have the desired physical properties at a low price point.

### BRIEF SUMMARY

The disclosure relates to a winder liner for unvulcanized rubber material comprising a first woven layer, a second woven layer, and a polymer layer disposed between the first woven layer and the second woven layer. The first and second woven layers each contain a plurality of warp tape elements in a warp direction interwoven with a plurality of weft tape elements in a weft direction and a plurality of interstices between the warp and weft tape elements. The polymer layer is disposed on the inner surfaces of the first woven layer and the second woven layer and in the interstices of the first woven layer and the second woven layer. The polymer layer contains a first polymer, the first polymer comprising a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements and weft tape elements of the first woven layer and the second woven layer. The application also discloses a winding system for unvulcanized rubber material, a method for making the winder liner for unvulcanized rubber material, and a method for making the winding system for unvulcanized rubber material.

### BRIEF DESCRIPTION OF THE DRAWINGS

FIG. 1 illustrates schematically a cross-section of an exemplary winder liner for unvulcanized rubber material.

FIG. 2 illustrates schematically a cross-section of an exemplary winding system for unvulcanized rubber material.

FIG. 3 illustrates schematically a cross-section of an exemplary winder liner for unvulcanized rubber material.

FIG. 4 illustrates schematically a cross-section of an exemplary winding system for unvulcanized rubber material.

FIG. 5 illustrates schematically a cross-section of an exemplary winding system for unvulcanized rubber material wound up.

FIG. 6 illustrates schematically a top view of an exemplary winding liner having indicia.

### DETAILED DESCRIPTION

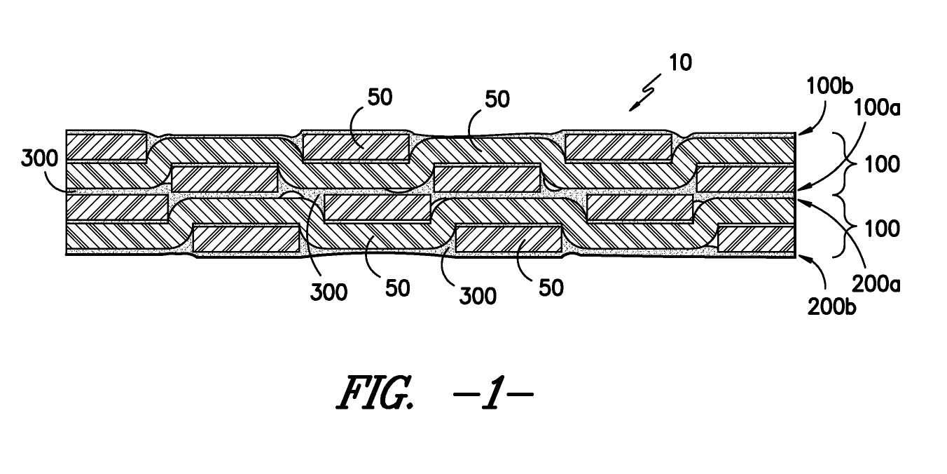

Referring now to FIG. 1, there is shown one embodiment of the winder liner for unvulcanized rubber materials. The winder liner 10 contains a first woven layer 100, a second winder layer 200, and a polymer layer 300. The first woven layer 100 has an inner surface 100a and an outer surface 100. The first woven layer 100 comprises a plurality of warp tape elements 50 in a warp direction interwoven with a plurality of weft tape elements 50 in a weft direction and a plurality of interstices between the warp and weft tape elements. The second woven layer 200 has an inner surface 200a and an outer surface 200. The first woven layer 200 comprises a plurality of warp tape elements 50 in a warp direction interwoven with a plurality of weft tape elements 50 in a weft direction and a plurality of interstices between the warp and weft tape elements. The winder liner also includes a polymer layer 300. The polymer layer 300 is disposed on the inner surfaces (100a, 200a) of the first woven layer and the second woven layer and in the interstices of the first woven layer and the second woven layer. It is also optionally located on the outer surfaces (100b, 200b) of the first woven layer 100 and the second woven layer 200 as shown in FIG. 1. The polymer layer 300 comprises a first polymer. The first polymer comprises a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements 50 and weft tape elements 50 of the first woven layer 100 and the second woven layer 200. The top and bottom side of the winder liner preferably have good release properties to rubber materials.

While the winder liner has been depicted in FIG. 1 as including two (2) woven layers 100, 200, those of ordinary skill in the art will readily appreciate that the winder liner can comprise any suitable number of woven layers. In one embodiment, the winder liner 10 contains one woven layer, only the first woven layer and the polymer layer 300 may be disposed on the inner and/or outer surface of the first woven layer. In other embodiments, the winder liner can comprise greater than two woven layers. By way of example only and not limitation, such structures may have three woven layers, four woven layers, five woven layers, or six woven layers. If the winder liner contains more than two woven layers, there may be polymer layers 300 between each of the woven layers or only between some of the woven layers.

The first woven layer 100 and the second woven layer 200 contain fibers in the warp and weft direction, where the fibers may be any suitable fiber. Preferably, the fibers are tape elements. Preferably, the tape elements are monofilament fibers having a rectangular cross-section and are continuous. The tape element is considered to have a rectangular cross-section even if one or more of the corners of the rectangular are slightly rounded or if the opposing sides are not perfectly parallel. Having a rectangular cross-section may preferred for a variety of reasons. Firstly, the surface available for bonding is greater. Secondly, during a de-bonding event the whole width of the tape is under tension and shear points are significantly reduced or eliminated.

In one embodiment, the tape elements have a cross-sectional shape with a width between about 0.05 mm and 10 mm more preferably between about 0.1 mm and 5 mm and a height between about 10 μm and 500 μm more preferably between about 20 μm and 200 μm. In one embodiment, the aspect ratio comparing the width of the rectangular cross-section to the height of the rectangular cross-section is between about 0.25 and 500.

The tape elements may be formed from any suitable material. Preferably, the tape elements comprise a thermoplastic polymer. Some suitable materials include, but are not limited to, polypropylenes, polyethylenes, polyesters, polyamides, polyethers, copolymers of any of the above; glass, aramid, carbon, ceramic, nylon, polyetherimide, polyamide-imide, polyphenylene sulfide, polysulfones, polyimide, conjugated polymers, mineral fiber, natural fibers, metallic fiber or mixtures thereof. In one embodiment, the tape elements 50 have a tensile modulus of greater than 10 grams per denier as measured by ASTM method 3811-07 and/or a tensile strength of at least 100 MPa. In one embodiment, the tape elements comprise polypropylene. Polypropylene may be preferred for some applications due to its strength, ability to be oriented, and low cost.

The tape elements 50 may be produced in any suitable manner. In one embodiment, the tape elements 50 may be formed by slitting a film. The film may be formed by any conventional means of extruding such multilayer polymeric films. By way of example, and not limitation, the film may be formed by blown film or cast film extrusion. The film is then cut into a multiplicity of longitudinal strips of a desired width by slitting the film to yield tape elements 10 having the desired cross-sections. The tape elements 50 may then be drawn in order to increase the orientation of the tape element so as to provide increased strength and stiffness of the material. In another embodiment, an already oriented (mono or bi axially) film is then slit into tape elements.

In another embodiment, the tape elements are extruded from a slit die then oriented. The process begins with slit extruding molten polymer to form fibers having a rectangular cross-section. The die typically contains between 5 and 60 slits, each one forming a fiber. In one embodiment, the each slit die has a width of between about 15 mm and 50 mm and a thickness of between about 0.6 and 2.5 mm. The fibers once extruded are typically 4 to 12 mm wide. The fibers may be extruded having one layer or may have a second layer and/or a third layer using co-extrusion.

The first and second woven layers 100, 200 may be any suitable textile layer. This includes but is not limited to a woven, nonwoven, unidirectional, or knit textile. The textile layer contains interstices which are spaces between the fibers of the textile layer. The tighter the textile layer construction, the smaller the interstices.

Preferably, the layers 100, 200 are woven layers where warp tape elements running in the warp direction are interwoven with weft tape elements running in the weft direction in transverse relation to the warp tape elements. The weft tape elements are interwoven with the warp tape elements such that a given weft extends in a predefined crossing pattern above and below the warp. In one embodiment, the weft tape elements and the warp tape elements are formed into a so called plain weave wherein each weft tape element passes over a warp tape element and thereafter passes under the adjacent warp tape element in a repeating manner across the full width of the woven layer. However, it is also contemplated that any number of other weave constructions as will be well known to those of skill in the art may likewise be utilized. By way of example only, and not limitation, it is contemplated that the weft tape elements may pass over two or more adjacent warp tape elements before transferring to a position below one or more adjacent warp fibers thereby forming a twill weave. The term “interwoven” is meant to include any construction incorporating inter-engaging formation fibers. In one embodiment, the woven layers 100, 200 are, for example, plain, satin, twill, basket-weave, poplin, jacquard, and crepe weave woven layers. Preferably, the woven layers 100, 200 are a plain weave woven layer. It has been shown that plain weaves have good abrasion and wear characteristics. A twill weave has been shown to have good properties for compound curves so may also be preferred for rubber articles.

The first and second woven layers 100, 200 may have the same or different constructions and/or materials. For example, the first woven layer 100 may contain polypropylene tape elements in a twill weave and the second woven layer 200 may contain polyester tape elements in a plain weave. In another example, both the first and second woven layers 100, 200 may have polypropylene tape elements in a plain weave, but the first woven layer 100 may have a higher pick count (meaning there are more tape elements per unit length) than the second woven layer 200. Having different constructions and/or materials between the two layers 100, 200 serves to have different physical characteristics on the two sides of the winder liner. In one embodiment, the constructions and materials of the first woven layer 100 and the second woven layer 200 are the same. This is preferred as it produces a balanced product where during storage and use the two sides of the winder liner behave the same way reducing curl of the winder liner.

In one embodiment, at least a portion of the warp tape elements 50 are fused to at least a portion of the weft tape elements 50 within the first woven layer 100. In another embodiment, at least a portion of the warp tape elements 50 are fused to at least a portion of the weft tape elements 50 within the second woven layer 200. This may be accomplished by using heat to partially melt and bond the elements together or by using an additional adhesive that may be heat, light, or monomer initiator, or UV activated. Having the warp tape elements and the weft tape elements being fused to one another (within the same woven layer) provides resistance to unraveling and may provide the winder liner with better tear resistance, higher tensile modulus, and better stability. A portion means at least one tape element is adhered to another tape element. Preferably, between about 1 and 99% of the warp tape elements are adhered to the weft tape elements. The amount of fusing between the tape elements is a function of the materials of the tape elements, the construction of the woven layers, and the processing of the winder liner 10.

In another embodiment, at least a portion of the warp tape elements 50 and weft tape elements 50 of the first woven layer 100 are fused to at least a portion of the warp tape elements 50 and weft tape elements 50 of the second woven layer 200. This inter-layer adhesion may provide resistance to unraveling and may provide the winder liner with better tear resistance, higher tensile modulus, and better stability. Preferably, between about 1 and 99% of the warp tape elements and weft elements of the first woven layer are adhered to the warp tape elements and weft elements of the second woven layer. The amount of fusing between the tape elements is a function of the materials of the tape elements, the construction of the woven layers, and the processing of the winder liner 10.

Referring back to FIG. 1, the winder liner 10 contains a polymer layer 300. The polymer layer 300 is disposed between the first woven layer 100 and the second woven layer 200 on the inner surfaces 100a, 200a of the woven layers 100, 200. The polymer layer 300 is also located in the interstices of the woven layers 100, 200. The polymer layer 300 at least partially fills at least a portion of the interstices of the woven layers 100, 200. Preferably, the polymer layer 300 fills a majority of the interstices (greater than 50% by number) at least 70% by volume. If the polymer layer 300 does not migrate to the outer surfaces 100b, 200b of the first and second woven layers, then the outer surface 100b of the first woven layer 100 and the outer surface 200b of the second woven layer 200 form the top and bottom sides of the winder liner 10.

Optionally, the polymer layer 300 may also migrate (during the calendaring step to form the winder liner) onto the outer surfaces 100b, 200b of at least one of the first woven layer 100 and the second woven layer 200. In one embodiment shown in FIG. 1, the polymer layer 300 is disposed on the outer surface 100b of the first woven layer 100 and the outer surface 200b of the second woven layer 200 forming skins on the outer surfaces 100b, 200b. This outer skin forms the top side and bottom side of the winder liner and provides a smooth surface for the unvulcanized rubber material so that the unvulcanized rubber material has no texture formed on its surface and has better rubber release properties.

The polymer layer 300 contains the first polymer and any other suitable material. The first polymer comprises a polymer that is preferably compatible with the material of the tape elements 50. “Compatible”, in this application, is defined as two or more polymers that are inherently or enhanced to remain mixed without objectionable separation over the range of processing conditions that will form the final product. “α-olefin”, in this application, is defined as 1-alkene olefin monomer units other than ethylene such as propylene, butylene, 4-methyl-1-pentene, pentene, 1-octene, and the like. “Melting temperature”, in this application, is defined to be the lower of the peak melting temperature or the temperature at which 50% of the polymer has melted from the solid state as measured by Differential Scanning calorimetry (DSC).

The first polymer is preferably a co-polymer having at least 50% α-olefin units. Preferably, the first polymer comprises a co-polymer having at least 50% propylene units, more preferably 80% propylene units, most preferably more than 82% propylene units. The first polymer comprises a number-average molecular weight of between about 7,000 g/mol and 500,000 g/mol, a viscosity of between about 2,500 and 150,000 cP measured at 170° C., and a melting temperature lower than the melting temperature of the exterior surface portion of the core. The first polymer has a viscosity of not greater than about 10% the viscosity of the first polymer measured at 170° C. If the polymer has a number-average molecular weight lower than 7,000 g/mol or a viscosity lower than 2500 cP, the first polymer may have reduced physical properties within the winder liner. In one embodiment, the first polymer has a weight average molecular weight of between about 20,000 and 40,000 g/mol, a number average molecular weight of between about 7,000 and 22,000 g/mol. In another embodiment, the first polymer comprises a number-average molecular weight of between about 7,000 g/mol and 50,000 g/mol. The melting temperature of the first polymer is preferably lower than the tape elements in order to fuse the layers together without compromising the integrity of the tape elements. In one embodiment, the first polymer has a melting temperature of at least about 10° C. lower than that of the tape elements, and preferably between about 15-40° C. lower.

In another embodiment, the viscosity of the first polymer is between about 4,000 and 120,000 cP measured at 170° C., more preferably between about 4,000 and 16,000 cP. In one embodiment, elongation at break is greater than about 200%, more preferably greater than about 400%. In one embodiment, the first polymer has cohesion strength of at least about 1 MPa, more preferably greater than about 4 MPa. Having cohesion strength in this range provides a polymer that resists tearing. In one embodiment, the tensile modulus of the second polymer is greater than about 0.1 MPa, preferably greater than about 0.5 MPa and most preferably greater than 1 MPa. The percentage by weight of the second polymer to the total weight of the fiber is between about 0.25% wt and 50% wt, more preferably between about 1% wt and 25% wt. In one preferred embodiment, the second polymer comprises a metallocene catalyzed propylene-ethylene co-polymer.

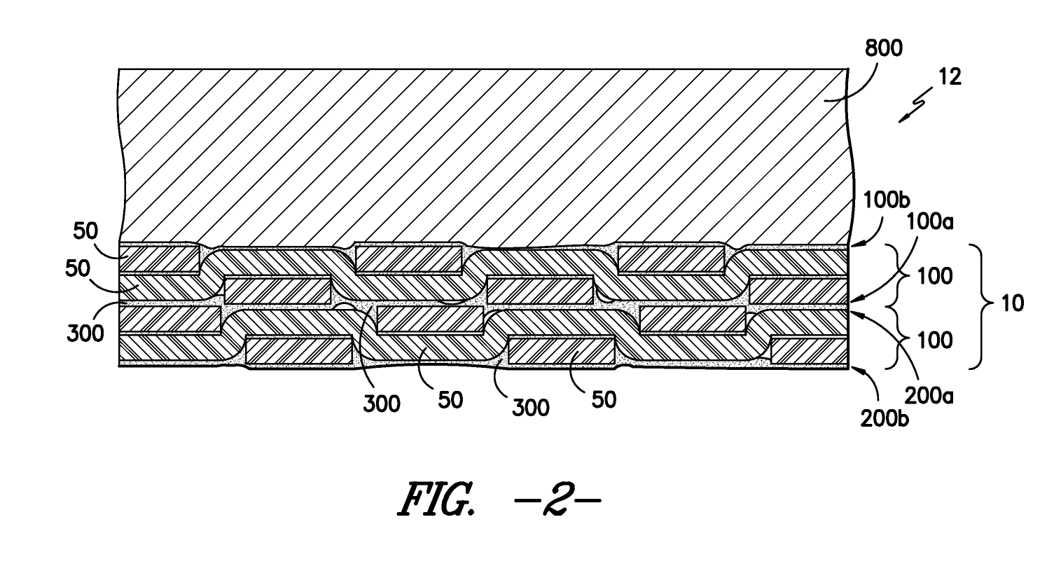

FIG. 2 illustrates the winder liner of FIG. 1 with a layer of unvulcanized rubber material 800 on the outer surface 100b of the winder liner forming a winding system for unvulcanized rubber material 12. The unvulcanized rubber material 800 is typically extruded onto the winder liner 10 and may be any suitable unvulcanized rubber material. In one embodiment, the unvulcanized rubber material is used to make tires.

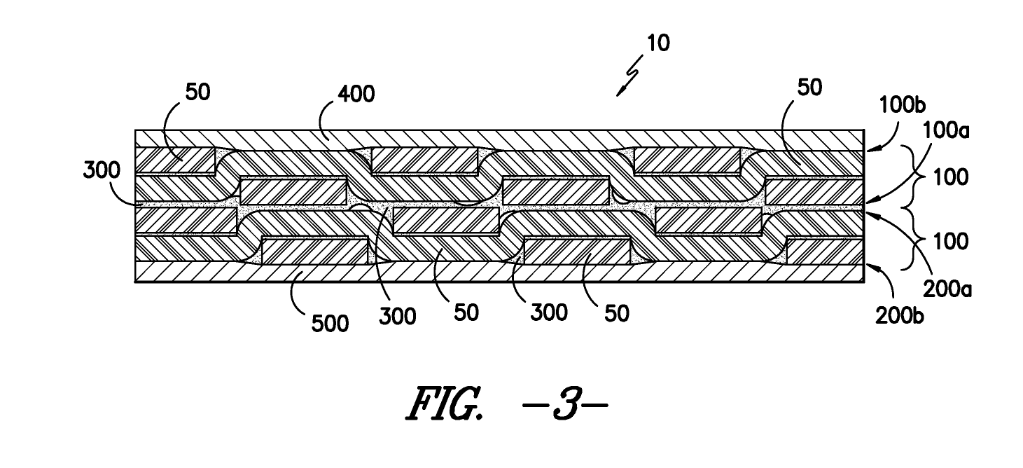

In one embodiment as shown in FIG. 3, a top polymer skin 400 may be disposed upon the first outer surface 100b of the first woven layer 100 (which forms an outer surface of the winder liner 10). This top polymer skin comprises a polymer selected from the group consisting of polyethylene, polypropylene, and polyethylene-polypropylene co-polymers. Preferably, the top polymer skin comprises a polyethylene-polypropylene co-polymer. The top polymer skin 400 serves to provide a smooth layer on the top side of the winder liner 10 to provide a smooth surface for the unvulcanized rubber material 800 and better release properties for the unvulcanized rubber material 800. In one embodiment, the thickness of the top polymer skin 400 may be between about 0.1 and 15 mils (approx. 2.5 to 375 micrometers), more preferably between about 1 and 5 mils (approx. 25 to 125 micrometers).

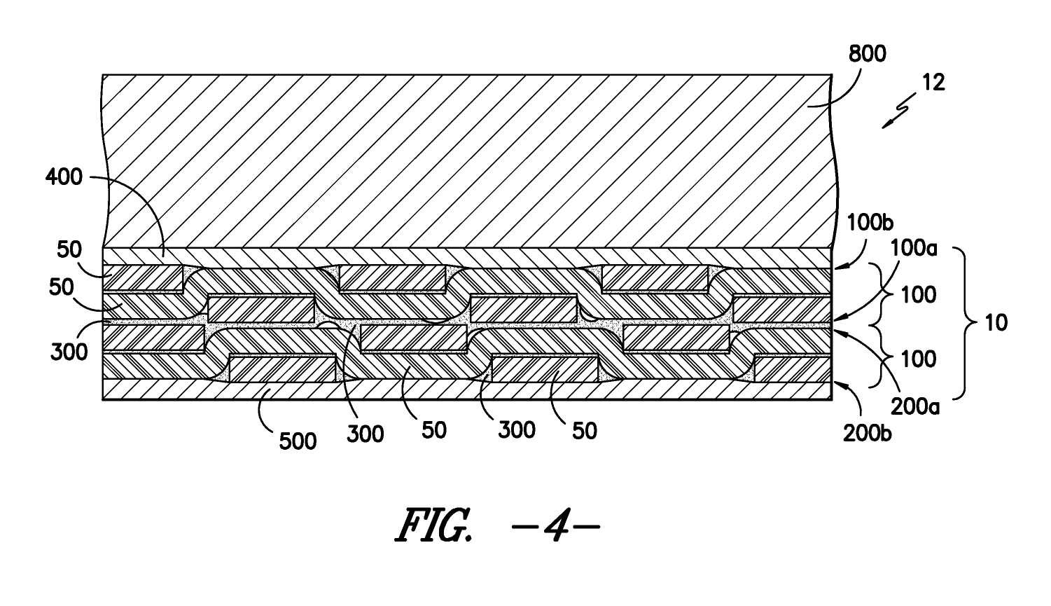

In another embodiment, a bottom polymer skin 500 may be disposed upon the second outer surface 200b of the second woven layer 200 (which forms an outer surface of the winder liner 10). This bottom polymer skin 500 comprises a polymer selected from the group consisting of polyethylene, polypropylene, and polyethylene-polypropylene co-polymers. Preferably, the bottom polymer skin 500 comprises a polyethylene-polypropylene co-polymer. The bottom polymer skin 500 serves to provide a smooth layer on the bottom side of the winder liner 10 to provide a smooth surface for the unvulcanized rubber material 800 and better release properties for the unvulcanized rubber material 800. In one embodiment, the thickness of the bottom polymer skin 500 may be between about 0.1 and 15 mils (approx. 2.5 to 375 micrometers), more preferably between about (approx. 25 to 125 micrometers). FIG. 4 illustrates the winder liner of FIG. 3 with a layer of unvulcanized rubber material 800 on the outer surface 100b of the winder liner forming a winding system for unvulcanized rubber material 12.

Any of the materials used in the winder liner 10, 12 may have any suitable additives or fillers. In one embodiment, the top polymer skin 400 and/or the bottom polymer skin 500 contain fillers in an amount of between about 0.5 and 20% wt of the skin, more preferably between about 7 and 15% wt of the skin. In one embodiment, this filler is a colorant, preferably a pigment. In another embodiment, the first woven layer 100, the second woven layer 200, and/or the polymer layer 300 contain colorants, preferably pigments. It may be preferred for a winder liner to have coloration so that in the manufacturing process it is easy to differentiate between different unvulcanized rubber materials or parts during manufacturing.

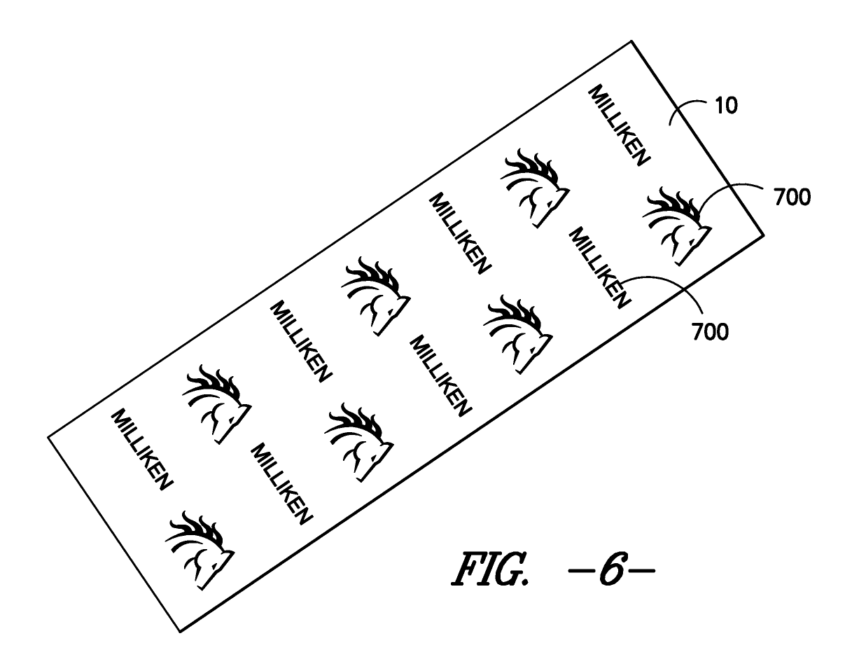

In another embodiment, the top and/or bottom side of the winder liner (the outer surface 100b, 200b of the woven layer, the polymer layer 300, the top polymer skin 400, or the bottom polymer skin 500 depending on the winder liner 10 construction) contains indicia as shown in FIG. 6. The indicia 700 on the winder liner 10 in FIG. 6 include text and images. Indicia include but are not limited to geometric patterns, images, text, logos, and graphics. These indicia may be preferred on a winder liner so that in the manufacturing process it is easy to differentiate between different unvulcanized rubber materials or parts during manufacturing. Additionally, it provides an opportunity to brand the liner. In one embodiment, the indicia are level with the surface of the winder liner. In this embodiment, no impression from the indicia is transferred to the unvulcanized rubber material. In another embodiment, the indicia are not level with the surface of the winder liner, with the indicia being below or above the surface of the winder liner. In this embodiment, an imprint of the indicia will be formed into the surface of the unvulcanized rubber material.

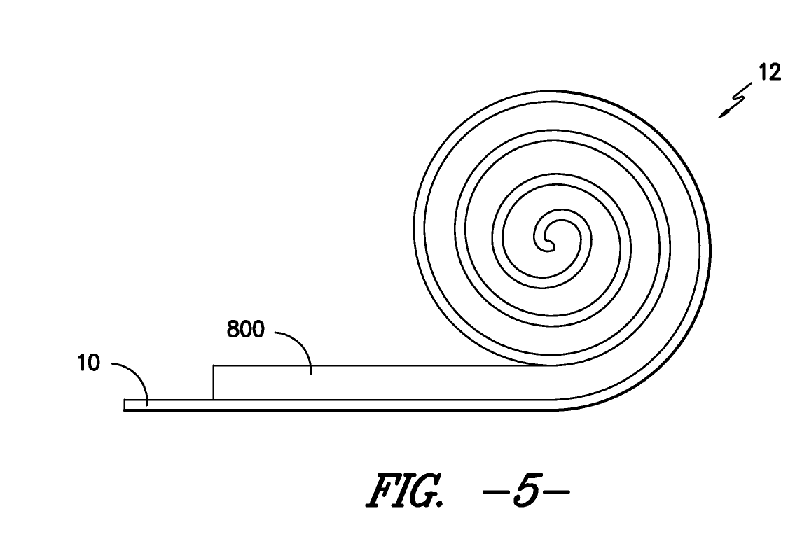

The winder liner system 12 may be left in flat sheets for further processing or may be wound-up into a roll as shown in FIG. 5. As shown in FIG. 5, the top and bottom sides of the winder liner 10 (the sub layers of the winder liner 10 are not shown to reduce complexity of the Figure) are both in contact with the unvulcanized rubber material 800, therefore it is typically important to have good smoothness and release properties on both sides of the winder liner 10.

One method for producing a winder liner for unvulcanized rubber material includes forming a first woven layer having an inner surface and an outer surface and comprising a plurality of warp tape elements in a warp direction interwoven with a plurality of weft tape elements in a weft direction and a plurality of interstices between the warp and weft tape elements and forming a second woven layer has an inner surface and an outer surface and comprises a plurality of warp tape elements in a warp direction interwoven with a plurality of weft tape elements in a weft direction and a plurality of interstices between the warp and weft tape elements, wherein the inner surface of the first woven layer faces the inner surface of the second woven layer.

In an alternative embodiment, a single woven layer may be used that is folded in half forming the first woven layer 100 and the second woven layer 200 which are attached along one edge.

Placing a polymer layer between the first woven layer and the second woven layer such that the polymer layer is adjacent the inner surface of the first woven layer and the inner surface of the second woven layer, wherein the polymer layer comprises the first polymer.

The placing a polymer layer between the first woven layer and the second woven layer may be performed in any suitable method. In one embodiment, the polymer layer is a free-standing film that is placed between the first and second woven layers. In other embodiment, the polymer layer is applied to one or both of the first and second woven layers by any known means including, but not limited to, solvent coating, curtain coating, extrusion coating, inkjet printing, gravure printing, solvent coating, powder coating, air knife coating, rod coating, electrostatic coating, slide hopper coating, blade coating, and slide coating. In one preferred embodiment, the polymer layer is applied as a molten extruded layer onto the inner surface of the first and/or second woven layer. In another preferred embodiment, the polymer layer is applied as an aqueous dispersion onto the inner surface of the first and/or second woven layer. The polymer layer may be continuous or discontinuous. If the polymer layer is discontinuous, the discontinuous layer may be patterned or random. The polymer layer may have the same thickness across the first and/or second woven layer or may have thickness variations across the woven layers.

Applying heat and optionally pressure to the first woven layer, polymer layer, and second woven layer causing at least a portion of the warp tape elements of the first woven layer to fuse to at least a portion of the weft tape elements of the first woven layer, at least a portion of the warp tape elements of the second woven layer to fuse to at least a portion of the weft tape elements of the second woven layer, at least a portion of the first polymer of the polymer layer to migrate into the interstices of the first woven layer, and at least a portion of the first polymer of the polymer layer to migrate into the interstices of the second woven layer. “Fused” is defined as being joined by melting together.

The winder liner layers are heated, preferably under pressure, to a temperature below the softening point of the tape elements 50 and preferably higher than the melting point of the polymer layer 300 (and the top skin layer 400 and the bottom skin layer 500, if being used). In so doing, the polymer layer will melt while the tape elements will remain substantially solid and oriented. When the winder liner is heated, optionally at least a portion of the warp tape elements 50 and weft tape elements 50 of the first woven layer 100 are fused to at least a portion of the warp tape elements 50 and weft tape elements 50 of the second woven layer 200. Optionally, the polymer layer 300 may also migrate (during the calendaring step to form the winder liner) onto the outer surfaces 100b, 200b of at least one of the first woven layer 100 and the second woven layer 200.

Consolidation may be performed by any suitable method. Heated batch or platen presses may be used for consolidation. In one exemplary practice, autoclaves or vacuum bags may be used to provide the pressure during consolidation. Continuous consolidation methods such as calendaring or use of a single or double belt laminator may likewise be employed. It is contemplated that any other suitable press may likewise be used to provide appropriate combinations of temperature, pressure, and residence time.

Optionally, the top skin layer 400 and/or the bottom skin layer 500 may be added to the winder liner at any point during the manufacture of the winder liner. For example the skin layer 400, 500 may be added after the woven layer 100, 200 are formed but before the polymer layer 300 is applied, after the polymer layer 300 is applied but before consolidation, or after consolidation of the winder liner. Preferably, the skin layers 400, 500 are applied after the woven layers 100, 200 are formed and added at approximately the same time the polymer layer 300 is added. If the skin layers 300, 400 are added before consolidation of the winder liner, then preferably winder liner layers are heated, preferably under pressure, to a temperature below the softening point of the tape elements 50 and preferably higher than the melting point of the polymer layer 300, the top skin layer 400, and the bottom skin layer 500. The top skin layer 400 and the bottom skin layer 500 serve to form a smooth surface with good rubber release properties. The top and/or bottom skin layers may contain fillers such as pigments.

The top skin layer 400 and the bottom skin layer 500 may be added to the winder liner by any known means including, but not limited to, solvent coating, curtain coating, extrusion coating, inkjet printing, gravure printing, solvent coating, powder coating, roller coating, air knife coating, rod coating, electrostatic coating, slide hopper coating, blade coating, and slide coating onto the woven layers 100, 200. In one preferred embodiment, the skin layers 400, 500 are applied as a molten extruded layer onto the outer surface of the first and/or second woven layer. The skin layers 400, 500 may be continuous or discontinuous. The skin layers 400, 500 may have the same thickness across the first and/or second woven layer or may have thickness variations across the woven layers. In one embodiment, the skin layers 400, 500 are free-standing films that are placed on the outer surfaces of the first and second woven layers.

If the winder liner contains indicia on the top and/or bottom side of the winder liner, the indicia may be applied by any known method, including but not limited to inkjet printing, gravure printing, patterned printing, thermal transfer, spray coating, and screen printing. Preferably, the indicia are in a color that is easily seen against the color of the winder liner.

Once the unvulcanized material is applied (preferably extruded) to the winder liner 10 forming the winder liner system 12, the winder liner system 12 may be left in flat sheets for further processing or may be wound-up into a roll as shown in FIG. 5. As shown in FIG. 5, the top and bottom sides of the winder liner 10 (the sub layers of the winder liner 10 are not shown to reduce complexity of the Figure) are both in contact with the unvulcanized rubber material 800, therefore it is typically important to have good smoothness and release properties on both sides of the winder liner 10.

The winder liner may contain additional fibers or layers. Examples of additional fibers that may be incorporated include, but are not limited to fibers made from highly oriented polymers, such as gel-spun ultrahigh molecular weight polyethylene fibers, melt-spun polyethylene fibers, melt-spun nylon fibers, melt-spun polyester fibers, sintered polyethylene fibers, rigid-rod polymers, carbon fibers, aramid fibers, glass fibers, polylactic acid fibers, and natural fibers such as cotton.

Additional layer such as polycarbonate films, polyester films, polyethylene films, and polypropylene films may be included into the winder liner.

### EXAMPLES

Various embodiments are shown by way of the Examples below, but the scope of the invention is not limited by the specific Examples provided herein.

### Test Methods

Tensile tests were done on a MTS tensile testing machine with a load capacity of 10,000 lb_{f}. The specimen size was ˜1 inch×10 inch with a gauge length of 5 inch. The test speed was 12 inches/minute. The breaking load was measured as the load at maximum force of the sample before breakage.

The tear strength tests were done on the MTS machine with a load capacity of 10,000 lb_{f}. The specimen size was −2 inch×10 inch with a gauge length of 5 inch. A tear was induced in the specimen at the mid-point of the sample (1 inch widths) and pulled in opposite directions. The test speed was 12 inches/minute. The tear strength was measured by the maximum force before the tear propagated.

The release tests were done on the MTS machine with a load capacity of 10,000 lbf. The specimen sizes were 1 inch×10 inch. For the release tests the composite sample was pressed onto a rubber specimen, specifically, Goodyear RA 306 obtained from Akron Rubber Compounding (Ohio, USA) in a platen press at room temperature and 10 tons for 1 minute. The release was measured as the force required for separating the composite laminate from the rubber specimen. The test speed was 12 inches/minute.

### Example 1

Woven fibrous layers were formed from monolayer polypropylene tape fibers in a plain weave with a fabric weight of 0.3 lb/yd². Two (2) fiber layers were cut to a foot square (12″×12″) and stacked. Powdered Licocene® 2602, a metallocene type of propylene-ethylene co-polymer obtained from Clariant and coated onto the fabrics. Licocene® 2602 had a viscosity of 6000 cP measured at 170° C. and a melting temperature of 75° C. The tensile modulus of Licocene® 2602 is measured to be roughly ˜0.7 MPa; has an elongation at break of 760% and cohesion strength of 9 MPa. The crystallinity of the polymer is ˜17%. The powder was layered in between 2 woven fibrous layers. The layers were placed between two aluminum platens consolidated at various temperatures (T=320° F., 300° F.) and pressures (P=2500 psi, 300 psi) for 10 minutes of heating time. The sample was then subsequently cooled to 100° F. The cooling rate was approximately 20° F./minute.

### Example 2

Licocene® 2602, a metallocene type of polypropylene-polyethylene co-polymer obtained from Clariant was used as received (Licocene® 2602 properties are described in Invention Example 1). Approximately 5 pounds of Licocene® was input into the adhesive bath of a gravure coater and melted at a temperature of 280° F. In the gravure coater the melted Licocene is taken up by the pattern on the gravure imprinter, the pattern being a dot pattern having a density of 66 dots/cm², each dot having a depth of 0.25 mm. When the fibrous layer to be printed is passed through a gravure imprinter, the graver physically transfers the Licocene onto the material. However at low melting bath temperatures, the viscosity of the polymer exceeds gravure printing limits and a thick film of polymer is coated on the fabric. On fabric layer were gravure coated with the Licocene® at a temperature of 280° F. After the woven tape layers were contacted by the gravure roll, they were attached on with a second fabric layer and then passed through a chill roll where the Licocene was cooled. The add-on weight of the Licocene onto the fibrous layer was 50% wt. Two (2) fiber layers were cut to a foot square (12″×12″) and stacked as in Example 1. The layers were placed between two aluminum platens consolidated at various temperatures (T=320° F., 300° F.) and pressures (P=2500 psi, 300 psi) for 10 minutes of heating time. The sample was then subsequently cooled to 100° F. The cooling rate was approximately 20° F./minute.

### Example 3

PP-5135C, a random copolymer of polypropylene and polyethylene obtained from Pinnacle Polymers was used as received. The polymer had a melt flow index of 35 gram/10 minutes, a tensile strength of 31.7 MPa and an elongation to yield of 11%. PP 5135C was extrusion coated onto the fabric at 550° F. and a thickness of 75 μm and a speed of 150 ft/minute. In extrusion coating application a very uniform film of the polymer is extruded through a film die and is coated onto a substrate. Using this method, very precise coatings can be obtained onto the substrate. Simultaneously along with this process a second layer of fabric is laminated onto the first coated layer using the same polymer as the bonding adhesive—PP 5135. Specifically, the adhesive is applied at 550° F. and is in molten form, and the fabric bonding step acts as the quenching phase. After lamination, a second coat is applied to the fabric through the same process as described above. The add-on weight of the PP 5135 onto the fibrous layer was 100% wt.

### Results

| | Tensile Strength | Tear Strength | Release Strength |
|---|---|---|---|
| Sample | (N/mm) | (N) | (N/mm) |
| Example 1 | 43.8 | 86.7 | ~0-0.011 |
| Example 2 | 34.8 | 95.2 | ~0-0.011 |
| Example 3 | 37.9 | 125 | ~0-0.011 |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A winder liner for unvulcanized rubber material having a top side and a bottom side comprising:
a first woven layer having an inner surface and an outer surface, wherein the first woven layer comprises a plurality of warp tape elements in a warp direction interwoven with a plurality of weft tape elements in a weft direction and a plurality of interstices between the warp and weft tape elements;
a second woven layer having an inner surface and an outer surface, wherein the inner surface of the second woven layer is adjacent the inner surface of the first woven layer, wherein the second woven layer comprises a plurality of warp tape elements in a warp direction interwoven with a plurality of weft tape elements in a weft direction and a plurality of interstices between the warp and weft tape elements; and,
a polymer layer disposed on the inner surfaces of the first woven layer and the second woven layer and in the interstices of the first woven layer and the second woven layer, wherein the polymer layer comprises a first polymer, wherein the first polymer comprises a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements and weft tape elements of the first woven layer and the second woven layer.

2. The winder liner for unvulcanized rubber material of claim 1, wherein at least a portion of the warp tape elements are fused to at least a portion of the weft tape elements within the first woven layer and wherein at least a portion of the warp tape elements are fused to at least a portion of the weft tape elements within the second woven layer.

3. The winder liner for unvulcanized rubber material of claim 1, further comprising a top polymer skin located on the outer surface of the first woven layer, wherein the top polymer skin comprises a polymer selected from the group consisting of polyethylene, polypropylene, and polyethylene-polypropylene co-polymers.

4. The winder liner for unvulcanized rubber material of claim 3, further comprising a bottom polymer skin located on the outer surface of the second woven layer, wherein the bottom polymer skin comprises a polymer selected from the group consisting of polyethylene, polypropylene, and polyethylene-polypropylene co-polymers.

5. The winder liner for unvulcanized rubber material of claim 3, wherein the top polymer skin comprises pigment in an amount of between about 0.5 and 20% wt of the first polymer skin.

6. The winder liner for unvulcanized rubber material of claim 1, wherein the warp and weft tape elements of the first and second woven layers comprise polypropylene.

7. The winder liner for unvulcanized rubber material of claim 1, wherein the top side of the winder liner comprises indicia.

8. A winding system for unvulcanized rubber material comprising:
a sheet of unvulcanized rubber material and a winder liner, wherein the winder liner has a top side and a bottom side and comprises:
a first woven layer having an inner surface and an outer surface, wherein the first woven layer comprises a plurality of warp tape elements in a warp direction interwoven with a plurality of weft tape elements in a weft direction and a plurality of interstices between the warp and weft tape elements;
a second woven layer having an inner surface and an outer surface, wherein the inner surface of the second woven layer is adjacent the inner surface of the first woven layer, wherein the second woven layer comprises a plurality of warp tape elements in a warp direction interwoven with a plurality of weft tape elements in a weft direction and a plurality of interstices between the warp and weft tape elements; and,
a polymer layer disposed on the inner surfaces of the first woven layer and the second woven layer and in the interstices of the first woven layer and the second woven layer, wherein the polymer layer comprises a first polymer, wherein the first polymer comprises a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements and weft tape elements of the first woven layer and the second woven layer,
wherein the sheet of unvulcanized rubber material is located on the top side of the winder liner.

9. The winder system for unvulcanized rubber material of claim 8, wherein at least a portion of the warp tape elements are fused to at least a portion of the weft tape elements within the first woven layer and wherein at least a portion of the warp tape elements are fused to at least a portion of the weft tape elements within the second woven layer

10. The winder system for unvulcanized rubber material of claim 8, further comprising a top polymer skin located on the outer surface of the first woven layer, wherein the top polymer skin comprises a polymer selected from the group consisting of polyethylene, polypropylene, and polyethylene-polypropylene co-polymers and a bottom polymer skin located on the outer surface of the second woven layer, wherein the bottom polymer skin comprises a polymer selected from the group consisting of polyethylene, polypropylene, and polyethylene-polypropylene co-polymers.

11. The winder system for unvulcanized rubber material of claim 8, wherein the warp and weft tape elements of the first and second woven layers comprise polypropylene.

12. A method of producing a winder liner for unvulcanized rubber material comprising:
(a) forming a first woven layer having an inner surface and an outer surface and comprising a plurality of warp tape elements in a warp direction interwoven with a plurality of weft tape elements in a weft direction and a plurality of interstices between the warp and weft tape elements;
(b) forming a second woven layer has an inner surface and an outer surface and comprises a plurality of warp tape elements in a warp direction interwoven with a plurality of weft tape elements in a weft direction and a plurality of interstices between the warp and weft tape elements, wherein the inner surface of the first woven layer faces the inner surface of the second woven layer;
(c) placing a polymer layer between the first woven layer and the second woven layer such that the polymer layer is adjacent the inner surface of the first woven layer and the inner surface of the second woven layer, wherein the polymer layer comprises a first polymer, the first polymer comprising a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements and weft tape elements of the first woven layer and the second woven layer; and,
(d) applying heat and optionally pressure to the first woven layer, polymer layer, and second woven layer causing:
at least a portion of the warp tape elements of the first woven layer to fuse to at least a portion of the weft tape elements of the first woven layer;
at least a portion of the warp tape elements of the second woven layer to fuse to at least a portion of the weft tape elements of the second woven layer;
at least a portion of the first polymer of the polymer layer to migrate into the interstices of the first woven layer; and
at least a portion of the first polymer of the polymer layer to migrate into the interstices of the second woven layer.

13. The method of claim 12, wherein step (c) placing the polymer layer between the first woven layer and the second woven layer comprises coating the polymer layer onto at least one of the outer surface of the first woven layer and outer surface of the second woven layer by a coating method selected from the group consisting of extrusion coating and aqueous coating.

14. The method of claim 12, further comprising applying a top polymer skin to the outer surface of the first woven layer, wherein the top polymer skin comprises a polymer selected from the group consisting of polyethylene, polypropylene, and polyethylene-polypropylene co-polymers and applying a bottom polymer skin to the outer surface of the second woven layer, wherein the bottom polymer skin comprises a polymer selected from the group consisting of polyethylene, polypropylene, and polyethylene-polypropylene co-polymers.

15. The method of claim 12, wherein the warp and weft tape elements of the first and second woven layers comprise polypropylene.

16. The method of claim 12, wherein the top polymer skin comprises pigment in an amount of between about 0.5 and 20% wt of the first polymer skin.

17. The method of claim 12, wherein the top side of the winder liner comprises indicia.

18. A method of producing a winder system for unvulcanized rubber material comprising:
(a) forming a first woven layer having an inner surface and an outer surface and comprising a plurality of warp tape elements in a warp direction interwoven with a plurality of weft tape elements in a weft direction and a plurality of interstices between the warp and weft tape elements;
(b) forming a second woven layer has an inner surface and an outer surface and comprises a plurality of warp tape elements in a warp direction interwoven with a plurality of weft tape elements in a weft direction and a plurality of interstices between the warp and weft tape elements, wherein the inner surface of the first woven layer faces the inner surface of the second woven layer;
(c) placing a polymer layer between the first woven layer and the second woven layer such that the polymer layer is adjacent the inner surface of the first woven layer and the inner surface of the second woven layer, wherein the polymer layer comprises a first polymer, the first polymer comprising a co-polymer having at least 50% α-olefin units and is characterized by a number-average molecular weight of about 7,000 g/mol to 500,000 g/mol, a viscosity of between about 2,500 and 150,000 cP measured at 170° C., and a melting temperature lower than the melting temperature of the warp tape elements and weft tape elements of the first woven layer and the second woven layer;
(d) applying heat and optionally pressure to the first woven layer, polymer layer, and second woven layer forming a winding liner having a top side and a bottom side causing:
at least a portion of the warp tape elements of the first woven layer to fuse to at least a portion of the weft tape elements of the first woven layer;
at least a portion of the warp tape elements of the second woven layer to fuse to at least a portion of the weft tape elements of the second woven layer;
at least a portion of the first polymer of the polymer layer to migrate into the interstices of the first woven layer;
at least a portion of the first polymer of the polymer layer to migrate into the interstices of the second woven layer; and,
(e) applying a sheet of unvulcanized rubber material onto the top side of the winder liner.

19. The method of claim 18, further comprising:
(f) optionally winding the sheet of unvulcanized rubber material and winding liner into a roll such that the sheet of unvulcanized rubber material is located between the top side of the winder liner and the bottom side of the winder liner.

20. The method of claim 18, wherein step (c) placing the polymer layer between the first woven layer and the second woven layer comprises coating the polymer layer onto at least one of the outer surface of the first woven layer and outer surface of the second woven layer by a coating method selected from the group consisting of extrusion coating and aqueous coating.

21. The method of claim 18, further comprising applying a top polymer skin to the outer surface of the first woven layer, wherein the top polymer skin comprises a polymer selected from the group consisting of polyethylene, polypropylene, and polyethylene-polypropylene co-polymers and applying a bottom polymer skin to the outer surface of the second woven layer, wherein the bottom polymer skin comprises a polymer selected from the group consisting of polyethylene, polypropylene, and polyethylene-polypropylene co-polymers.

22. The method of claim 18, wherein the warp and weft tape elements of the first and second woven layers comprise polypropylene.
